(19) United States
(12) Patent Application Publication
(10) Pub. No.: US 2003/0037628 A1
(43) Pub. Date: Feb. 27, 2003

(54) Device for converting straight-line motion to rotary motion

(76) Inventor: Remy Chave, Bobigny Cedex (FR)

Correspondence Address: MORGAN & FINNEGAN, L.L.P., 345 PARK AVENUE, NEW YORK, NY, 10154, US

(21) Appl. No.: 10/226,908

(22) Filed: Aug. 23, 2002

(30) Foreign Application Priority Data
Aug. 23, 2001 (FR) 0111148

(51) Int. Cl. F16H 21/16

(52) U.S. Cl. 74/89

(57) ABSTRACT

Linear motion of the rod of an actuator is converted into limited rotary motion of a rotatable system. This rotary motion is about an axis defined by a manoeuvring member which is coupled to the actuator rod by a coupling member. The two ends of the coupling member are fixed rigidly to the manoeuvring member and actuator rod respectively. These ends are joined through a flexible element.

### FIELD OF THE INVENTION

The present invention relates to device for driving a rotatable system in rotation about an axis, in response to straight-line or translational movement of the output member of a linear actuator.

### BACKGROUND OF THE INVENTION

When it is desired to change the orientation of a device of reduced weight and size in directions lying within a fairly limited angular range, current practice is to employ a system such as that shown diagrammatically in FIG. 1 of the attached drawings. In FIG. 1, this device comprises a linear actuator 10, having an output rod 12 which is displaceable in straight line movement. The linear actuator 10 is fixed on a base (not shown) on which the system which is to be controlled in rotational motion is arranged to pivot about a pivot axis 14.

The rotatable device includes a manoeuvring member 16 in cooperation with a coupling member 18 which is connected to the control member displaceable in linear motion, which consists of the output rod 12. The coupling member 18 is fixed to the output rod 12 of the actuator 10. Cooperation between the manoeuvring member 16 and coupling member 18 is provided by means of a pin 20 which is fixed to the coupling member 18 and which is received, in sliding movement, within a slot 22 formed in the manoeuvring member 16. In order to avoid any risk of jamming, and in order to facilitate control, a certain amount of clearance is provided between the pin 20 and the edges of the slot 22.

As a result, positioning of the rotatable system controlled by the device cannot be ensured with much accuracy. In addition, the angle of rotation about the axis 14 is not proportional to the distance travelled by the output rod 12 of the actuator. In this connection, simple consideration shows that it is the tangent of the said angle that is proportional to the course of travel of the output rod. Consequently, control of the movement of the output rod of the actuator must take this into account, which complicates the law governing the operation of the device and the control circuit.

In order to try and resolve these problems arising from the need to provide a fitting clearance for the rotatable device, it has been proposed to connect the output member 12 of the actuator 10 and the manoeuvring member 16 together by means of a rigid link 24 which is articulated at both ends on the two members 12 and 16 respectively, as shown in FIG. 2 of the accompanying drawings. While this solution does minimise positioning, or fitting, clearances, it does not however resolve the problem of proportionality between the angle of rotation and the course of travel of the output rod of the actuator. In this case the relationship between these Is two values is defined by a relatively complex function.

### DISCUSSION OF THE INVENTION

An object of the present invention is to propose a device for driving in rotation a system which is rotatable about an axis of rotation, in movement derived from straight-line movement of the output member of a linear actuator, in which the device does not have any positioning clearance and the angle of rotation of the rotatable system is proportional to the course of travel of the output member of the actuator, the device being reliable, easy to install, and uncomplicated.

The invention is accordingly directed to a device for driving a rotatable system in rotation about an axis in response to the straight line motion of a control member which is adapted to be driven in linear motion, the rotary system being fixed with respect to a manoeuvring member, the latter co-operating with a coupling member which is connected to the linear motion control member.

According to the invention, the coupling member has a first end which is secured rigidly to the manoeuvring member of the rotatable system, and a second end which is secured rigidly to the said control member.

Some preferred but optional features of the invention are as follows:

the coupling member is made of a flexible material and has high resistance to elongation over a predetermined length of the said material;

the coupling member consists of a cable formed of spiral wound metallic strands;

the coupling member consists of a compound spring with interlocking turns;

the coupling member is of piano wire;

the coupling member consists of a spring steel strip;

the coupling member is made from plastics material or consists of a carbon fibre rod;

an end piece is secured to at least one end of the cable, the end piece being secured rigidly on the manoeuvring member or control member;

the end piece is secured to the cable by seaming, welding or in situ moulding;

one of the end pieces includes at least one extension portion which is arranged to meet a stop surface formed on the other end piece if excessive stress causes the flexible material to elongate.

Further features and advantages of the present invention will appear more clearly on a reading of the following detailed description of some preferred embodiments of the invention, which is given by way of non-limiting example only and with reference to the accompanying drawings.

### BRIEF DESCRIPTION OF THE DRAWINGS

FIG. 1, already discussed above, is a diagrammatic representation of a rotary driving device in the prior art.

FIG. 2, also discussed above, is a diagrammatic representation of another rotary driving device in the prior art.

FIG. 3 is a diagrammatic view of a rotary driving device according to the present invention, shown in a first position.

FIG. 4 is a diagrammatic view of the rotary driving device of FIG. 3 in a second position.

FIG. 5 shows one example of a coupling member which is suitable for use in the rotary driving device of the invention.

FIG. 6 shows another example of a coupling member which can be used in the driving device of the invention.

FIG. 7 is a perspective view showing a modified version of the rotary driving device of the present invention, shown in a rest position.

FIG. 8 is a perspective view showing the version of FIG. 7 in a working position.

FIG. 9 is a side view of the driving device in the same position as in FIG. 7.

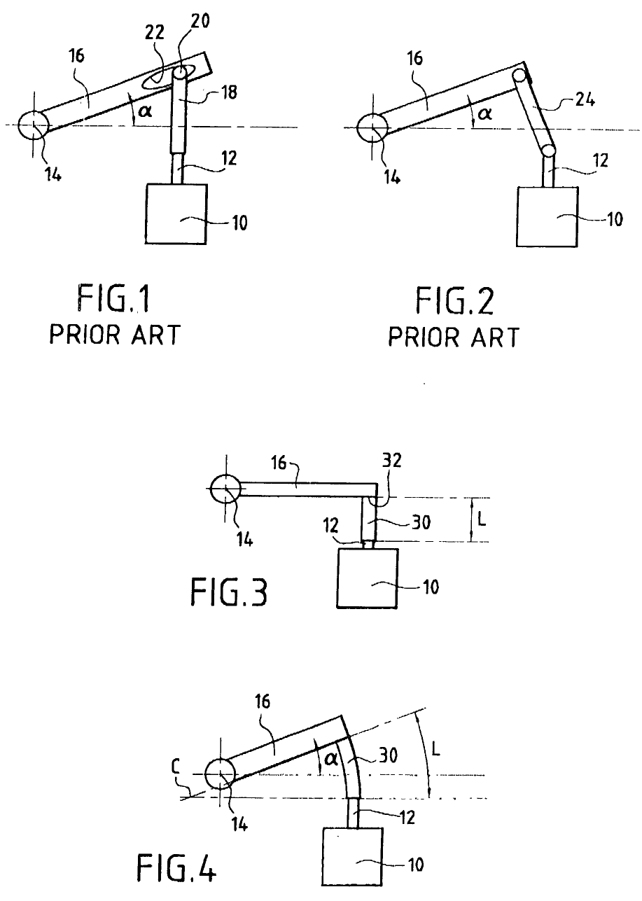

### DESCRIPTION OF PREFERRED EMBODIMENTS OF THE INVENTION

In the various Figures of the drawings, those elements which are identical, or which perform the same purpose, as each other are given the same reference signs.

Reference is first made to FIGS. 3 and 4. In the rotary driving device shown diagrammatically in FIGS. 3 and 4, as in the prior art, the device includes a linear actuator 10, the output rod 12 of which is displaceable in straight-line axial motion (or translational movement). The linear actuator 10 is fixed on a base (not shown) on which the device which is to be controlled in rotational movement by the driving device is pivoted by means of a pivot pin on an axis 14. The rotatable device also includes a manoeuvring member 16 whereby it is possible to control the angular position of a rotatable device about the axis 14.

A coupling member 30 is arranged between the manoeuvring member 16 and the control member 12, the coupling member 30 including a flexible element made of a flexible material having a predetermined length L. Such a material may consist for example of a metallic cable consisting of a number of strands spiral-wound in the manner of a traction cable, or a spring steel clip, or a piano cord or, in general, any flexible material having high resistance to elongation over a length L of the flexible element. Materials responding to these conditions also include plastics materials and rods made from carbon fibres, as well as springs with interlocking turns.

The flexible element of the coupling member 30 is fixed with respect to both the manoeuvring member 16 and the control member 12. FIG. 5, to which reference is now made, shows such a flexible element in the form of a metallic cable 32 having a number of spiral-wound strands, which is suitable for use in a device according to the invention. FIG. 5 shows that the cable 32 is fixed at each end to an end piece 34 and 36 respectively. These end pieces 34 and 36 are, in their turn, secured rigidly on the manoeuvring member 16 and the output rod 12 respectively. The cable 32 may be secured to the end pieces 34 and 36 by seaming, welding, in situ moulding, or in any other suitable way. In the case of a spring steel strip, the ends of this strip may be screwed or welded on the manoeuvring member 16 and control member 12.

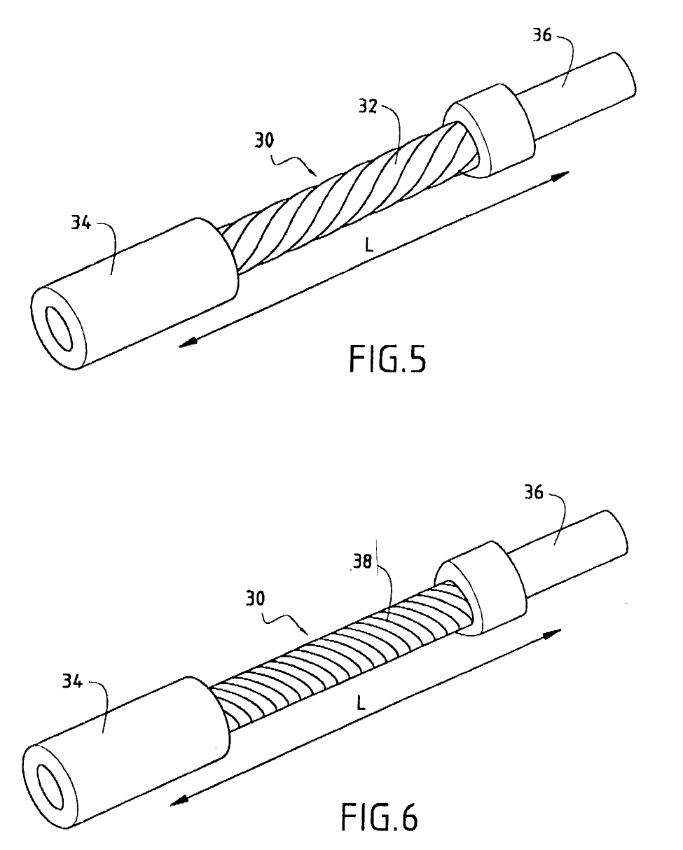

Referring now to FIG. 6, this shows another flexible element 38, which is made of a flexible material but which has high resistance to elongation over the whole length L of the element 38, which in this case is a compound spring, consisting of springs with interlocking turns. The compound spring is preferably made from wire having a square cross section. As in the version shown in FIG. 5, the spring 38 is fixed at each end to an end piece 34 and 36, these end pieces being in their turn secured rigidly on the manoeuvring member 16 and output member 12 respectively. The spring 38 may be fastened to the end pieces 34 and 36 by, for example, any of the methods mentioned above in connection with the end pieces in FIG. 5.

FIG. 3 shows the state of the driving device when the output rod 12 of the actuator 10 is occupying an extreme position in which it is fully drawn into the body of the actuator 10. The mounting of the actuator 10 on the base which carries the pivot pin 14 is such that, in this position, the axis of the output rod 12 of the actuator passes through the point 32 at which the coupling member 30 is fixed on the manoeuvring member 16. As a result, in this position, which will be referred to as the rest position, the coupling member 30 is straight (rectilinear), and constitutes a true extension of the output rod 12.

When the actuator 10 is operated in such a way that the output rod 12 emerges from the body of the actuator, the latter exerts a pushing force on the coupling member 30, which in its turn exerts a pushing force on the manoeuvring member 16. The assembly therefore adopts a position such as that shown in FIG. 4. In this connection, since one of the ends of the coupling member 30 is fixed to the push rod 12, it remains as an extension of the latter while the output rod 12 is in motion. Similarly, because the other end of the coupling member 30 is fixed to the manoeuvring member 16, it stays at right angles to the latter while the output rod 12 is in motion. On the other hand, because the middle part of the coupling member is flexible and not subjected to any stress, it is free to deform so as to transmit the motion from the output shaft 12 to the manoeuvring member 16.

Experience shows that the manoeuvring member adopts a form which is very close to that of an arc of a circle centred on the point C of intersection of straight lines passing through the fastening points of the coupling member 30 on the output rod 12 and manoeuvring member 16. As a result, because the length L of the coupling member 30 is constant because it is resistant to elongation, the manoeuvring member 16, and therefore the device which is rotatable about the axis 14 defined by the manoeuvring member 16, turns through an angle a which is proportional to the course of travel of the output rod 12.

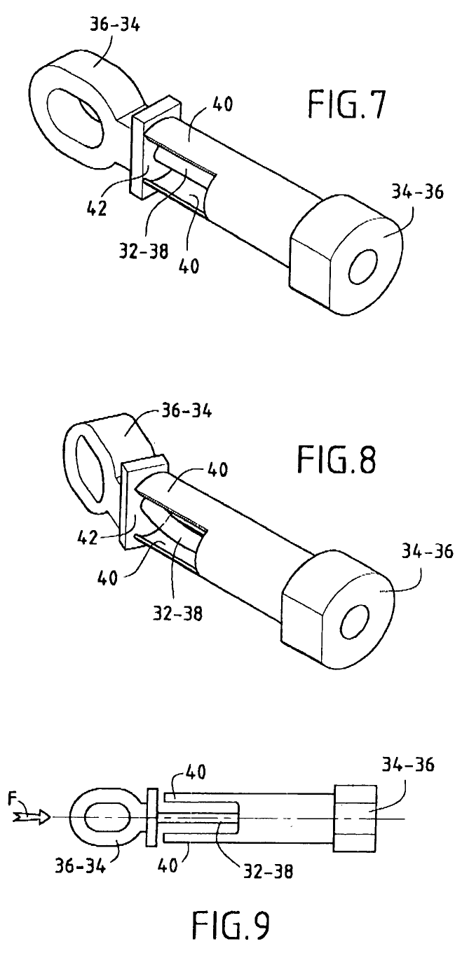

In order to be certain that no elongation effect is able to disturb the operation of the driving device, an end stop could be provided for giving maximum limitation for this effect. This is what is shown in FIGS. 7 to 9, to which reference will now be made.

One of the end pieces, 34 or 36, includes at least one (two in the example shown) extension portions 40 which extend parallel to the flexible element of the coupling member 30 when the latter is in its rest position. The extension portions 40 extend as far as the vicinity of a surface 42 which is formed on the other end piece, 36 or 34 respectively.

In order that the extension portion 40 (or each portion 40) will not prevent bending of the flexible element of the coupling member 30 during operation, the extension portion is disposed, with respect to the flexible element such as 32 or 38, in a plane that passes through the axis of rotation 14 of the manoeuvring member 16. Thus, as is shown in FIG. 8, when the flexible element is bending so as to adopt a curved configuration, nothing will interfere with it during its movement.

On the other hand, during handling, transport or installation of the driving device, if a stress is applied to it in the direction of the arrow F in FIG. 9, and is such as to tend to elongate the flexible element, the two end pieces will come into contact with each other via the surface 42 co-operating with one or two extension portions 40. As a result, it is possible to increase the flexibility of the flexible element without detriment to the reliability of the driving device.

It will therefore be seen that, for a device of reduced weight and size which it is desired to orientate in directions lying within a limited angular range, the invention provides a device for driving a rotatable system in rotation about an axis of rotation, in motion derived from, or responsive to, straight-line motion of the output member of a linear actuator having no positioning or fitting clearance, and in which the angle of rotation of the rotatable system is proportional to the course of travel of the output member of the actuator. Such a driving device is particularly simple, and is also reliable, while it is easy to install and uncomplicated.

What is claimed is:

1. A driving device for converting limited linear motion to limited rotary motion, for effecting said limited rotary motion of a rotatable system about an axis of rotation, the device comprising actuating means including a control member and means mounting the control member for linear movement, the device further including a manoeuvring member adapted to be fixed with respect to the said rotatable system and defining the said axis of rotation, and a coupling member connected to the manoeuvring member for cooperation therewith and further connected to the said control member, wherein the coupling member includes a first end portion and a second end portion at opposite ends of the coupling member, the said end portions being fixed to the said manoeuvring member and control member respectively.

2. A device according to claim 1, wherein the coupling member comprises a flexible element with high resistance to elongation over a predetermined length thereof.

3. A device according to claim 2, wherein the said flexible element is a cable spiral wound from metal strands.

4. A device according to claim 2, wherein the said flexible element consists of a spring with interlocking turns.

5. A device according to claim 2, wherein the said flexible element is of piano wire.

6. A device according to claim 2, characterised in that the said flexible element is a spring steel strip.

7. A device according to claim 2, wherein the said flexible element is an elongate member of a material selected from the group consisting of plastics material and carbon fibre.

8. A device according to claim 3, wherein the coupling member comprises an end piece fixed to at least one end of the cable, with said end piece being rigidly secured on a member selected from the group consisting of the manoeuvring and control members.

9. A device according to claim 8, wherein the end piece is fixed to the cable by a process selected from the group consisting of seaming, welding and in situ moulding.

10. A device according to claim 2, wherein one said end portion defines a stop surface facing towards the other end portion, the said other end portion having at least one extension portion extending towards the said stop surface, for cooperation with the latter in the event of excessive stress causing the said flexible element to elongate.
